(19) United States
(12) Patent Application Publication
(10) Pub. No.: US 2026/0326224 A1
(43) Pub. Date: Oct. 22, 2026

(54) ELECTRODE WIRE AND METHOD FOR THE PRODUCTION THEREOF

(71) Applicant: THERMOCOMPACT, Epagny Metz-Tessy (FR)

(72) Inventors: Michel Ly, Epagny Metz-Tessy (FR); Pierro Cadio, Epagny Metz-Tessy (FR)

(73) Assignee: THERMOCOMPACT, Epagny Metz-Tessy (FR)

(21) Appl. No.: 19/491,142

(22) PCT Filed: May 13, 2024
(86) PCT No.: PCT/EP2024/063123

§ 371 Date: Dec. 8, 2025

(30) Foreign Application Priority Data
Jun. 7, 2023 (FR) FR2305738

(51) Int. Cl. B23H 7/24

(52) U.S. Cl. CPC B23H 7/24

(57) ABSTRACT

The electrode wire (2) for electroerosion machining has a metal core (10) having a peripheral face, the metal core being made of a single copper-zinc alloy, and a layer (12) of zinc oxide formed directly on the peripheral face of the metal core and covering this peripheral face, the average thickness of the zinc oxide layer (12) being in a range of from 100 nm to 461 nm.

### FIELD OF THE INVENTION

The invention concerns a electrode wire for EDM machining and a method of manufacturing the electrode wire.

Electrode wires are used to cut metals or electrically conductive materials by electroerosion in an EDM machine.

### BACKGROUND ART

The well-known electrical discharge machining (EDM) process removes material from an electrically conductive workpiece by generating sparks in a machining zone between the workpiece and an electrically conductive electrode wire. The electrode wire runs continuously in the vicinity of the workpiece in the direction of the wire length, held by guides, and is moved progressively in the transverse direction towards the workpiece, either by transverse translation of the wire guides, or by translation of the workpiece.

An electrical generator, connected to the electrode wire via electrical contacts away from the machining zone, establishes a suitable potential difference between the electrode wire and the conductive workpiece to be machined. The machining zone between the electrode wire and the workpiece is immersed in a suitable dielectric fluid. The potential difference between the electrode wire and the workpiece generates sparks that progressively erode the workpiece and the electrode wire. The longitudinal movement of the electrode wire ensures that the wire diameter is always sufficient to prevent wire breakage in the machining zone. Relative movement of the wire and workpiece in the transverse direction enables the workpiece to be cut or its surface to be treated, as required.

The particles detached from the electrode wire and the workpiece by the sparks are dispersed in the dielectric fluid, where they are discharged.

To achieve machining precision, particularly when making small-radius angle cuts, it is needed to use small-diameter wires that can withstand a high mechanical breaking load, so that they can be tensioned in the machining zone and limit the amplitude of vibrations.

Most modern EDM machines are designed to use metal wires, typically 0.25 mm in diameter, with a breaking load of between 700 N/mm² and 1,000 N/mm².

When a spark occurs between the electrode wire and the workpiece, the surface of the electrode wire is suddenly heated to a very high temperature for a short time. As a result, the material in the surface layer of the electrode wire at the site of the spark changes from solid to liquid or gas, and is displaced on the electrode wire surface and/or discharged into the dielectric fluid. It is observed that the outer face of the electrode wire affected by the spark is deformed, generally taking on a slightly concave crater shape, with zones where the material has been melted and solidified again.

It has been shown that the efficiency of spark erosion depends largely on the nature and topography of the electrode wire surface layer. For this reason, considerable progress in EDM efficiency has been achieved by using electrode wires comprising:
a metal core made of one or more metals or alloys ensuring good conduction of the electric current and good mechanical strength to hold the mechanical tensile load of the wire, and
a coating of one or more other metals or alloys and/or a particular topography, e.g. fractures, ensuring improved EDM efficiency, e.g. higher erosion speed.

For example, U.S. Pat. No. 8,338,735B2 describes a electrode wire with a brass core covered by a copper-zinc alloy layer. In this application, the copper-zinc alloy layer comprises a fractured gamma-phase copper-zinc alloy mixture.

This particular coating structure is generally designed to ensure higher machining speeds for EDM workpieces.

Electrode wire manufacturing methods, such as the one described in U.S. Pat. No. 8,338,735B2, generally involve depositing a layer of zinc on the metal core, typically by electroplating. This is a complex and energy-intensive method.

Application JPS61203223A describes a electrode wire having a brass core coated with a layer of zinc oxide. The zinc oxide layer is obtained by placing a brass wire in a furnace heated to 600° C. for 4 hours. This high-temperature heat treatment is carried out at a very low pressure of around 0.05 atm (5.07 kPa). The result is an oxidized brass wire with a 300 nm layer of zinc oxide. At this stage of manufacture, the oxidized brass wire obtained is not usable in most EDM machines, as its breaking load is not greater than 400 N/mm². To make this oxidized brass wire usable in most EDM machines, it is then drawn from a diameter of 0.4 mm to a diameter of 0.2 mm. The wire-drawing operation increases the tensile strength of the oxidized brass wire, making it suitable for use in EDM machines. However, the zinc oxide layer obtained by heating at high temperature under very low pressure is very brittle. As a result, much of the zinc oxide is lost during the drawing process. So, after drawing, instead of obtaining a zinc oxide layer 150 nm thick, the thickness of the zinc oxide layer is much smaller, less than 100 nm. In addition, since the zinc oxide layer obtained is very brittle, when this wire is used to machine a workpiece, the zinc oxide layer crumbles and soils the electrode wire guides. To remedy this latter drawback, application JPS61203223A proposes coating the oxidized brass wire with a layer of varnish after drawing. However, coating the oxidized brass wire with a layer of varnish is not satisfactory. This is because the varnish layer is insoluble in water. As a result, when machining a part with an oxidized brass wire coated with such a varnish, the varnish is not dissolved by the water present during machining and therefore remains on the electrode wire. This disrupts the flow of current between the electrode wire and the workpiece during machining.

Prior art is also known from JPS61103731A, DE202017106956U1 and US2019/233919A1. The teaching of the JPS61103731A application is similar to that of the JPS61203223A application. In particular, in the JPS61103731A application, oxidation of the brass core is also carried out under very low pressure, which leads to the formation of a friable zinc oxide layer that is largely removed during drawing. Furthermore, the temperature and time conditions described in JPS61103731A for oxidizing the brass core are similar to those described in JPS61203223A, so that this also leads to electrode wires whose breaking load, before drawing, is insufficient for use in most EDM machines. Application DE202017106956U1 discloses only zinc oxide layers with thicknesses of less than 100 nm. US2019/233919A1 does not disclose a zinc oxide layer formed directly on a brass core.

### SUMMARY OF THE INVENTION

The aim of the invention is to provide a electrode wire whose performance is similar to that of the electrode wire described in U.S. Pat. No. 8,338,735B2, while being simpler to manufacture.

The invention is set out in the attached set of claims.

### BRIEF DESCRIPTION OF THE DRAWINGS

The invention will be better understood on reading the following description, given only as a non-limiting example and made with reference to the drawings on which:

FIG. 1 is a schematic illustration of the cross-section of a electrode wire,

FIG. 2 is a flow chart of a method for manufacturing the electrode wire shown in FIG. 1,

FIG. 3 is a front view of a guide used to measure the frictional resistance of a wire,

FIG. 4 is a longitudinal section view of the guide shown in FIG. 3, and

FIG. 5 is a top view of the guide shown in FIG. 3.

### DETAILED DESCRIPTION OF PARTICULAR EMBODIMENTS

In these figures, the same references are used to designate the same elements. In the remainder of this description, features and functions well known to the skilled person are not described in detail.

In Section I, definitions of certain terms are given. In Chapter II, an example of a detailed embodiment is described with reference to the figures. Then, in Chapter III, variants of these embodiments are presented. Finally, in Chapter IV, the advantages of the various embodiments are described.

### Chapter I: Definitions and Terminology

The expression “element made of material A” or “material A element” designates an element in which material A represents at least 70%, by mass, of this element and preferably at least 90% or 95% by mass of this element.

A “copper-zinc alloy” is an alloy made entirely of copper and zinc, apart from unavoidable impurities. A copper-zinc alloy is also called “brass”.

The term “electrically conductive” refers to a material whose electrical conductivity at 20° C. is greater than 106 S/m, and preferably greater than 107 S/m.

The longitudinal axis of a wire is the axis along which the wire mainly extends.

The term “cross-section” refers to a section of the electrode wire perpendicular to its longitudinal axis.

The term “longitudinal section” refers to a section of the electrode wire made along a plane containing its longitudinal axis.

The term “layer” refers to an annular layer of the electrode wire that lies, in each cross-section of the electrode wire, between an inner and an outer circular boundary. In reality, these boundaries are not perfect circles. However, as a first approximation, in this text, these boundaries are assimilated to circles. These circular boundaries are both centered on the electrode wire axis. The inner circular boundary is the boundary of the layer closest to the electrode wire axis. Conversely, the outer circular boundary is the boundary of the layer furthest from the electrode wire axis. Between these inner and outer circular boundaries, the chemical composition is substantially homogeneous. Conversely, at the inner and outer circular boundaries, the chemical composition changes abruptly. In particular, the change in composition when these circular boundaries are crossed is far greater than the slight changes in composition that can be observed within a layer.

The term “fractured layer” refers to a layer with multitude fractures dividing it into multitude zones separated from each other, in a longitudinal section of the wire, by a very large number of radial fractures. A very large number of radial fractures means, over a length of 1 mm of the electrode wire, more than a dozen radial fractures which divide the layer in question into a dozen of blocks mechanically isolated from one another, in the longitudinal section, by these radial fractures.

The term “surface layer” refers to the outermost layer of the electrode wire. This surface layer may have a thin film of water-soluble residues, such as drawing lubricant residues, on its surface. The outer face of this surface layer is therefore either merged with the outer face of the electrode wire in the absence of the thin film, or separated from the outer face of the electrode wire solely by this thin film. Conversely, a electrode wire layer coated with a varnish, as in the case of the electrode wire described in application JPS61203223A, is not a surface layer because the varnish applied on it is not water-soluble.

Ambient temperature” refers to a temperature between 15° C. and 35° C., typically 25° C.

The average thickness e of a zinc oxide surface layer is defined by the following relationship (1): e=[mᵢ−m_{f}]/[ρ*π*d*L], where:
mᵢ is the initial mass of a wire sample with a zinc oxide surface layer,
m_{f} is the mass of the same wire sample after being immersed in a bath that completely dissolves the surface layer of zinc oxide,
ρ is the volume density of the zinc oxide. Here, p is taken to be 5600 kg/m³,
π is the number pi,
d is the initial diameter of the wire sample before it is immersed in the bath which completely dissolves the oxide layer,
L is the length of the wire sample, and
“*” is the symbol for scalar multiplication.

The average thickness e is, for example, measured using the following procedure:
1) A sample of wire length L and diameter d is taken and wound into a coil of approximately 5 cm diameter. Length L is, for example, 12 m. The diameter d is often equal to 0.25 mm.
2) The sample is rinsed with water, then dried and dusted with compressed air.
3) The initial mass mᵢ of the sample is measured using a precision balance.
4) The sample is then soaked for 20 to 30 seconds in a stirred aqueous bath of 8% to 12% sulfuric acid, at a temperature of 42° C. to 48° C.
5) The sample is rinsed with water.
6) The sample is dried using a jet of compressed air.
7) The final mass m_{f} of the sample is measured using a precision balance.
8) The average thickness e of the sample is calculated using relationship (1) above. Unless otherwise specified, in the remainder of this text, the term “zinc oxide layer thickness” alone refers to the average thickness of the zinc oxide layer.

A “straight” wire is a wire with a deflection of less than 35 mm when measured using the following method:
1) Place a 35 cm to 45 cm long piece of wire on a horizontal, sliding surface, so that it can bend freely. The piece of wire placed on this horizontal plane then forms an approximate arc of a circle.
2) Place a 30 cm-long straight ruler on the horizontal plane so that each end of the straight ruler is in contact or almost in contact with a respective point on the wire. The ends of the ruler are brought into contact with the wire with sufficient care to ensure that the wire is not deformed.
3) Measure the maximum distance between the wire and the ruler. This maximum distance corresponds to the wire's sag. The wire deflection is generally halfway between the ends of the ruler.

A “non-straight” wire is one that is not straight.

### Chapter II: Example of a Realization Mode

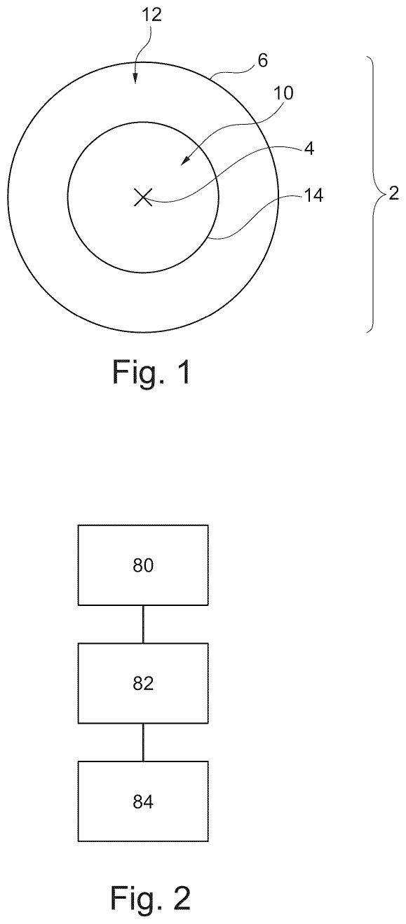

FIG. 1 shows a electrode wire 2 for EDM machining as described in the introductory section of this text.

To this end, the electrode wire 2 has a breaking load greater than 400 N/mm² and, more often, greater than 450 N/mm² or 500 N/mm² or 700 N/mm². The breaking load of electrode wire 2 is also generally less than 1100 N/mm². Here, the breaking load of electrode wire 2 is within one of the following ranges [400 N/mm²; 450 N/mm²], [400 N/mm²; 500 N/mm²], [450 N/mm²; 700 N/mm²], [500 N/mm²; 700 N/mm²] or greater than 700 N/mm². Wire EDM machining can be straight, slightly conical or highly conical. Machining is said to be “straight” when the angle α between the electrode wire and the face of the workpiece positioning table is between 82° and 98°. This table is generally horizontal. Machining is said to be “slightly conical” when the angle α is between 67° and 82° or between 98° and 113°. Machining is said to be “highly conical” when the angle α is between 45° and 67° or between 113° and 135°. Electrode wires with a breaking load in the range [400 N/mm²; 450 N/mm²] or [400 N/mm²; 500 N/mm²] are generally used for highly conical machining. Electrode wires with a breaking load in the range [450 N/mm²; 700 N/mm²] or [500 N/mm²; 700 N/mm²] are generally used for slightly conical machining. Electrode wires with a breaking load greater than 700 N/mm² are used for straight machining. It should also be pointed out that electrode wires with a breaking load of over 500 N/mm² can be made straight by stress-relief annealing, which is not the case for electrode wires with a breaking load of less than 450 N/mm². Straight electrode wires are easier to thread and mount in an EDM machine than non-straight electrode wires. For this reason, wire 2 is hereafter a wire with a breaking load greater than 500 N/mm².

The wire 2 extends along a longitudinal axis 4. Axis 4 is perpendicular to the sheet plane. The length of wire 2 is greater than 1 m and, typically, greater than 10 m or 50 m.

Wire 2 has an outer face 6 which is directly exposed to sparks when machining a workpiece by electrical discharge machining (EDM) using this wire. The outer face 6 is cylindrical and extends along axis 4. The directrix curve of face 6 is essentially a circle centered on axis 4. Thus, the cross-section of wire 2 is circular. The outer diameter D₂ of wire 2 is typically between 50 μm and 1 mm, and more often between 70 μm and 400 μm. Here, the diameter D₂ is 0.25 mm.

In this embodiment, the wire 2 comprises:
a central core 10 made of electrically conductive material, and
a coating 12 applied directly to the core 10.

The function of core 10 is to ensure, on its own, most of the breaking load of wire 2. It also ensures the electrical conductivity of wire 2. For this purpose, it is made of an electrically conductive material. Typically, it is made of metal or a metal alloy.

Core 10 has a mainly cylindrical peripheral face 14 extending along axis 4. This peripheral face 14 is made of a copper-zinc alloy. For this purpose, core 10 is made entirely of a single copper-zinc alloy. For example, the single copper-zinc alloy of core 10 is an α-phase copper-zinc alloy or a copper-zinc alloy formed from a mixture of α and β phases. In particular, core 10 does not have a central portion of copper-zinc alloy in one phase covered by a layer of copper-zinc alloy in another phase. Typically, the zinc concentration in core 10 is greater than 20 atomic % (atomic percent or “at. %”) and preferably greater than or equal to 36 atomic % or 40 atomic %. Typically, the zinc concentration in core 10 is less than 42 atomic %.

The diameter D₁₀ of core 10 is greater than 0.99*D₂ or 0.995*D₂. For example, here the diameter D₁₀ is greater than or equal to 0.249 mm.

Coating 12 is designed to increase machining speed and thus the erosive efficiency of the electrode wire and/or the quality of the faces of the part obtained after EDM machining. The lower the roughness, the better the quality of an EDM-cut face.

The average thickness of the coating 12 is very small compared to the diameter D₂ of the wire 2, i.e. less than 0.5% of the diameter D₂ and, preferably, less than 0.25% of the diameter D₂.

In this embodiment, the coating 12 consists of a single layer of zinc oxide. Hereafter, the same numerical reference is used to designate both the coating 12 and the zinc oxide layer.

Layer 12 is the surface layer of the electrode wire 2.

The average thickness e₁₂ of layer 12 is between 160 nm and 461 nm, preferably between 160 nm and 350 nm or between 160 nm and 300 nm.

In this embodiment, layer 12 is essentially made of zinc oxide of the formula ZnO.

In places, however, the layer 12 may be penetrated by brass spikes. These brass peaks form protrusions on the peripheral face 14 of the core 10, which penetrate the layer 12. These brass spikes form a single block of material with the core 10.

The composition of the zinc oxide may deviate slightly from stoichiometry. Composition analyses carried out using XPS (X-ray Photoectron Spectroscopy) spectra have shown that the zinc oxide in layer 12 is composed, in atomic percent:
over 90% zinc and oxygen,
more than 5% copper, and
various manufacturing residues.

During these composition analyses, the presence of carbon and carbon compounds on the surface of layer 12 was not taken into account. In fact, this carbon comes from the lubricant used during the wire-drawing stage. According to the analyses carried out, zinc oxide corresponds to zincite.

A method for manufacturing wire 2 will now be described with reference to FIG. 2.

For the implementation of this manufacturing method, typically, the desired thickness e₁₂ is first chosen between 100 nm and 461 nm or between 105 nm and 461 nm and, preferably, between 160 nm and 461 nm or between 160 nm and 350 nm. For example, here the thickness e₁₂ is taken to be equal to 200 nm. Next, the value of a coefficient c₁ described below is chosen in compliance with the constraints also described below. For example, here the coefficient c₁ is chosen to be equal to two. Finally, a diameter D₀ is chosen as a function of the previously chosen coefficient c₁ and the desired final diameter D₂, while complying with the constraints set out in the following paragraph. By way of illustration, the final diameter D₂ is taken to be equal to 0.25 mm.

In a step 80, a brass blank wire is first provided. The blank wire is a brass wire with a diameter D₀ between 1.3*D₂ and 6*D₂ and, preferably, between 1.3*D₂ and 3.75*D₂ or between 2*D₂ and 3.75*D₂. In this example, the diameter D₂ is equal to 0.25 mm so that the diameter D₀ is between 0.325 mm and 1.5 mm and, preferably, between 0.5 mm and 1.5 mm or between 0.5 mm and 0.94 mm. Here, the diameter D₀ is taken to be 0.5 mm.

The zinc concentration of this blank wire is chosen as described above for core 10. Here, the zinc concentration of the blank wire is 40 atomic %. The higher the zinc concentration, the better the performance of wire 2.

In this embodiment, the blank wire with the desired diameter D₀ is obtained by drawing a brass wire of standard diameter Dᵢₙᵢ to the desired diameter D₀. For example, the diameter Dᵢₙᵢ is 1.25 mm.

Then, in a step 82, the blank wire is oxidized to obtain an oxidized blank wire. The oxidized blank wire has a layer of zinc oxide directly on its peripheral face. This zinc oxide layer completely covers the peripheral face of the oxidized blank wire. To this end, in step 82, the supplied blank wire is subjected to heat treatment in the presence of oxygen. This heat treatment is carried out in a gaseous medium containing oxygen and at a pressure in excess of 50 kPa or 100 kPa. Here, this heat treatment is simply carried out in the earth's atmosphere, i.e. in a medium containing more than 20%, by volume, of oxygen, at ambient pressure of around 101 kPa. This heat treatment is configured to generate a layer of zinc oxide on the peripheral face of the blank wire whose average thickness e₀ is between 130 nm and 600 nm and, generally, between 160 nm and 600 nm. Indeed, a thickness e₀ of less than 130 nm does not enable a thickness e₁₂ of 100 nm or more to be obtained after the drawing step 84 described below. On the other hand, it has been observed that a thickness e₀ greater than 600 nm leads to a zinc oxide layer that does not adhere well and is stripped off, at least in places, during drawing step 84. This stripping off of part of the zinc oxide layer during drawing step 84 makes precise control of the thickness e₁₂ impossible. Indeed, it is very difficult to determine in advance the amount of zinc oxide that will be stripped off during drawing step 84 and therefore to predict in advance the thickness e₁₂ obtained after drawing step 84. Thus, when the thickness e₀ is greater than 600 nm, the reproducibility of the manufacturing method is degraded. Indeed, even if all the manufacturing parameters are kept equal, the differences between the thicknesses e₁₂ of the wires 2 manufactured increase. In addition, the stripping of part of the zinc oxide constitutes a waste of material that should be avoided or limited, since the stripped zinc oxide is not used in the manufactured wire 2.

Within the range [130 nm; 600 nm], the thickness e₀ is determined by successive experiments, testing several thicknesses e₀ within this range, until the thickness e₀ is found which, after drawing, gives the desired thickness e₁₂ of zinc oxide. In particular, when determining the thickness e₀, it must be taken into account that, even if the thickness e₀ remains below 600 nm, a small fraction of the zinc oxide is stripped off during the drawing step. It has been estimated that, at present, this small fraction of zinc oxide can be as high as 20% or 30%. It is emphasized that such a small fraction of zinc oxide lost during the drawing process remains much lower than the fraction of zinc oxide lost if the thickness e₀ were chosen to be greater than 600 nm or 800 nm. Indeed, for a thickness e₀ greater than 600 nm or 800 nm, the fraction of zinc oxide lost during drawing is greater than 50% or 67%. Typically, the e₀ thicknesses tested are chosen in the range [c₁*e₁₂; Min(1.3*c₁*e₁₂; 600)] and, preferably, in the range [1.1*c₁*e₁₂; Min(1.3*c₁*e₁₂; 600)] and, even more often, in the range [1.2*c₁*e₁₂; Min(1.3*c₁*e₁₂; 600)], where:
c₁ is equal to the diameter reduction coefficient of the oxidized blank wire in drawing step 84, and
Min(a;b) is the function that returns the smallest of the values a and b.

The reduction coefficient c₁ is defined as the ratio D₀/D₂. Thus, when the thickness e₁₂ is equal to 200 nm and the coefficient c₁ is equal to two, the thickness e₀ which makes it possible to obtain the desired thickness e₁₂ after drawing is typically between 480 nm and 520 nm and, most often, equal to or very close to 500 nm.

Here, the heat treatment used consists of placing a coil of the supplied blank wire in an furnace, under air, heated to a constant temperature T_{four} for a duration D_{four} and at ambient pressure. Here, the furnace is not airtight, and the air is circulated throughout the heat treatment process. The oxidation rate of the brass of the blank wire increases as a function of temperature T_{four}. As a result, the thickness of the zinc oxide layer forming on the blank wire increases more rapidly the higher the temperature T_{four}. Similarly, the thickness of the zinc oxide layer forming on the blank wire increases as a function of duration D_{four}. Thus, by adjusting the temperature T_{four} and the duration D_{four}, it is possible to obtain the desired thickness e₀ of zinc oxide.

More specifically, it has been established that thickness e₀, temperature T_{four} and duration D_{four} are related to each other, to a first approximation, by the following relationship (2): D_{four}=e₀²/[k*exp(−Q/(R*T_{four}))], where:
k=2.418*10⁻⁷ m²/s,
Q=152 kJ/mol,
R=8.314 J/mol/K, and
exp( . . . ) is the exponential function.

Using relationship (2), it is possible to estimate a theoretical value D_{fourT} of the duration D_{four} to obtain a given thickness e₀ at a given temperature T_{four}. This is illustrated in the following table for the particular case where the thickness e₀ is equal to 600 nm. This table shows the theoretical value D_{fourT}, in hours and fractions of an hour, required to achieve a zinc oxide thickness of 600 nm for different temperatures T_{four}.

| T_{four} (° C.) | D_{fourT} (h) |
|---|---|
| 200 | 25287835 |
| 250 | 628198 |
| 300 | 29741 |
| 350 | 2297 |
| 400 | 260 |
| 450 | 39.7 |
| 500 | 7.73 |
| 550 | 1.84 |
| 600 | 0.51 |
| 650 | 0.17 |
| 700 | 0.06 |
| 750 | 0.02 |

Subsequently, several trials with different values of the duration D_{four} chosen around the theoretical value D_{fourT} may be necessary to obtain the precise value of the duration D_{four} which enables the desired thickness e₀ to be obtained exactly. Typically, the D_{four} duration value selected as a result of these tests is in the range [0.8*D_{fourT}; 1.2*D_{fourT}] or in the range [0.9*D_{fourT}; 1.1*D_{fourT}] or in the range [0.95*D_{fourT}; 1.05*D_{fourT}].

Furthermore, the temperature T_{four} is preferably chosen not to be too high, so as to correspond to a duration D_{four} long enough to ensure that the time required for the temperature to be uniform throughout the coil is very small compared with the duration D_{four}. Indeed, if the temperature T_{four} chosen is very high, then the corresponding duration D_{four} is very short. However, over a very short period of time, the heat does not have time to spread evenly throughout the coil. Thus, in the case where the heat treatment consists of placing an entire coil of blank wire inside an furnace, when the duration D_{four} is very short, the thickness e₀ of the oxide layer formed presents strong inhomogeneity along the oxidized blank wire. To avoid this problem, the duration D_{four} is advantageously chosen to be greater than four or six hours. This constraint makes it possible to determine a maximum value for the temperature T_{four} which must not be exceeded. On the other hand, duration D_{four} must not be too long to be suitable for an industrial production process. For this purpose, the temperature T_{four} is chosen between 400° C. and 500° C.

At the end of duration D_{four}, the coil of blank wire is removed from the furnace. At this point, the blank wire is covered with a layer of zinc oxide of thickness e₀. It is therefore referred to as “oxidized blank wire”. After removal from the furnace, the coil is cooled. Typically, this involves exposing the coil to ambient air for the time required to cool it down to room temperature. This completes step 82.

In step 82, zinc oxidation consumes the zinc present in the brass. As a result, the zinc concentration in the brass of the blank wire in the vicinity of the zinc oxide layer is generally lower than that in the brass in the vicinity of axis 4.

Then, in step 84, the oxidized and cooled blank wire is cold-drawn to produce wire 2. “Cold” refers to the fact that drawing step 84 is carried out without heating the blank wire prior to diameter reduction. During step 84, the diameter reduction coefficient c₁ is used to bring the diameter D₀ of the blank wire to the desired diameter D₂ for wire 2, i.e. a diameter of 0.25 mm.

During step 82 and, in particular, during heat treatment, the brass recrystallizes, which reduces the breaking load of the blank wire. At the end of step 82, the breaking load of the oxidized blank wire is well below 700 N/mm², so that such a wire cannot be used as an electrode wire at this stage. In order to achieve a breaking load greater than 700 N/mm², it has been determined that the coefficient c₁ must be greater than or equal to 1.3. More precisely, the higher the coefficient c₁, the higher the breaking load. Thus, preferably, the coefficient c₁ is greater than or equal to 1.6 or 2.25, which makes it possible to obtain breaking loads greater than 800 N/mm² and 900 N/mm² respectively. The coefficient c₁ must also be less than 6 to keep the thickness e₀ below 600 nm. In the case where the diameter D₂ is equal to 0.25 mm, a coefficient c₁ equal to 1.3 requires the diameter D₀ to be greater than 0.325 mm and less than 1.5 mm. Here, the coefficient c₁ is chosen equal to two to obtain a breaking load of between 700 N/mm² and 800 N/mm².

It is emphasized that if the value of the coefficient c₁ chosen results in a thickness c₁*e₁₂ greater than 600 nm, then the coefficient c₁ and/or the thickness e₁₂ must be reduced to have, at the same time, a coefficient c₁ greater than 1.3 and a thickness e₀ less than 600 nm.

Here, in step 84, the oxidized blank wire is drawn under the same conditions as those suitable for non-oxidized brass wire. Diameter reduction is achieved by passing the oxidized blank wire successively through several dies of decreasing diameter, so as to progressively reduce the diameter of the oxidized blank wire until the desired diameter D₂ is reached. For example, dies with elongations of between 15% and 22% are used. A water-soluble lubricant is used to draw the oxidized blank wire. Here, for example, the lubricant is an aqueous solution containing the water-soluble lubricant.

It is this drawing that can create the brass peaks that penetrate layer 12.

At the end of step 84, once the diameter D₂ has been reached, an in-line stress-relief annealing operation is carried out before winding. This stress-relief annealing minimizes residual stresses in the wire 2 to obtain a straight wire 2 and thus facilitate its threading in an EDM machine. This stress-relief annealing does not modify the composition of wire 2 and has little effect on its tensile strength. To achieve this, wire 2 is tensioned between an upstream and a downstream pulley, and the portion of wire 2 between these two pulleys is heated as the wire 2 runs between these pulleys. For example, the portion of wire 2 stretched between the two pulleys is heated by Joule effect by passing an electric current through this portion of wire. The temperature and duration of this stress-relief annealing are much lower than those used in step 82. Typically, the temperature for stress relief annealing is between 300° C. and 450° C. and the duration is less than 2 s or 3 s. Immediately after stress relief annealing, the electrode wire is preferably quenched to cool it rapidly to room temperature. For this purpose, the electrode wire is dipped into a cold bath, i.e. a bath whose temperature is less than or equal to room temperature. Various solutions are available for dipping the wire in this cold bath immediately after stress-relief annealing. For example, the downstream pulley, in the wire running direction, is dipped in this cold bath. Alternatively, just after the downstream pulley, the wire passes through the cold bath. Here, the cold bath is an aqueous solution of polyethylene glycols (PEG). The average molar mass of the PEG used is between 200 and 1400 g/mol. PEG molecules may be present in the aqueous solution as ethoxylated esters of dicarboxylic acids. The concentration of PEG in this aqueous solution is typically between 2% and 20% by volume, the remainder being water.

To demonstrate the benefits of a electrode wire with a thick layer of zinc oxide on its surface, the following tests were carried out. A reference EDM machining job was defined. This involved cutting a punch out of a 50 mm-high workpiece of steel, with guides located less than 0.2 mm from the workpiece. Cutting is carried out on a CUT200MS machine marketed by GF Machining Solution. Cutting is carried out in three machining passes, using a technology adapted to brass. During each pass, the speed of movement of the part in relation to the electrode wire was adapted to cut the punch as quickly as possible with the same final surface finish. Here, this final surface finish corresponds to a roughness Ra of 0.6 μm. More precisely, in the tests carried out, only the speeds of movement of the workpiece relative to the electrode wire in the first and second passes were adapted according to the wire used. The speed of movement of the workpiece in relation to the electrode wire in the third pass is the same for all the tests carried out.

Using the manufacturing method shown in FIG. 2, different wires 2 were produced with different thicknesses e₁₂. Punch machining times using the different wires 2 are shown in the table below. In this table, the first column shows the wire designation. The second column shows the thickness e₁₂ and the third column the corresponding machining time, expressed in hours and fractions of an hour. In this table, the wires designated L7 and L49 are identical to wire 2, except that their thickness e₁₂ is not between 100 nm and 461 nm. The wire designated “Gamma” is an electrode wire as taught in patent U.S. Pat. No. 8,338,735B2. It comprises a surface layer of gamma-fractured copper-zinc alloy. More specifically, this is the electrode wire marketed by Thermocompact® under the reference Thermo SA.

| Wire | e₁₂ (nm) | Time (h) |
|---|---|---|
| L7 | 7 | 0.88 |
| L49 | 49 | 0.87 |
| L106 | 106 | 0.84 |
| L146 | 146 | 0.82 |
| L218 | 218 | 0.80 |
| L252 | 252 | 0.79 |
| L280 | 280 | 0.80 |
| L380 | 380 | 0.83 |
| L436 | 436 | 0.79 |
| Gamma | 44 | 0.82 |

As illustrated by these tests, wire 2 can machine almost as fast as wire “Gamma” from the moment the thickness e₁₂ is greater than 100 nm. Moreover, for thicknesses e₁₂ greater than 160 nm, it becomes possible to machine faster than the “Gamma” wire. For example, the thickness e₁₂ is preferably between 160 nm and 350 nm or between 160 nm and 300 nm.

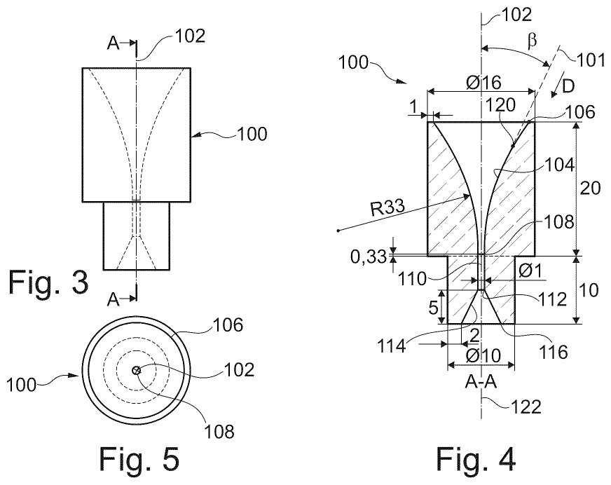

Furthermore, it has been validated that the wire 2 produced has a friction resistance equal to or better than that of a standard wire. To this end, the friction resistance of wire 2 is less than or equal to 7 mg/km and, preferably, less than 5 mg/km. Accordingly, wire 2 does not soil the wire guides of an EDM machine any more than a standard wire. Here, the standard wire is identical to wire 2 except that it is uncoated. The standard wire is therefore made entirely of brass. For this purpose, the frictional resistance of wire 2 and standard wire were measured using the following method:
Step 1): at room temperature, run 1 km of wire at a speed of 80 m/min under a tension of 12 N over a friction face of a guide 100 (FIGS. 3 to 5), the wire coming into contact with this friction face along a straight path 101 parallel to a direction D, then
Step 2): weigh the amount of dust that has come off the wire when the kilometer of wire has run its course.

The weight of this dust is a measure of the wire's friction resistance, expressed in mg/km. Indeed, the more friable the zinc oxide layer and/or the weaker its adhesion to the core, the greater the quantity of zinc oxide stripped off when it rubs against the rubbing face of the 100 guide.

FIGS. 3 to 5 show in detail the guide 100 used in the friction resistance measurement method. In FIG. 4, dimensions are given in millimeters.

Guide 100 is a solid of revolution. Its axis of revolution bears reference 102. The cross-section of the guide 100 shown in FIG. 4 is made along a sectional plane A-A which contains the axis 102. Thus, only the elements located on one side of axis 102 in FIG. 4 are described in detail. The other elements, on the opposite side, can be deduced by rotation symmetry around axis 102. In FIGS. 3 to 5, axis 102 is vertical.

The guide 100 has a friction face 104 whose longitudinal cross-section in sectional plane A-A forms an arc of a circle that begins at an inlet 106 and ends at an outlet 108. The tangent of the arc at outlet 108 is parallel to axis 102. The radius of the arc is 33 mm. The orthogonal projection of this circular arc on axis 102 forms a line 19.67 mm long. The orthogonal projection of this circular arc on a plane perpendicular to axis 102 forms a line 6.5 mm long.

After outlet 108, the face 104 continues downwards into a cylindrical face 110 parallel to axis 102. The horizontal section of face 110 is a circle centered on axis 102 with a diameter greater than the wire diameter. Here, the diameter of face 110 is 1 mm.

Moving downwards, the face 110 terminates in a circular opening 112 which forms the entrance to a truncated cone-shaped face 114.

The truncated cone-shaped face 114 is centered on the axis 102. This face 114 flares downwards to an outlet opening 116.

Face 104 is made of a much harder material than brass or zinc oxide. Here, face 104 is made of ceramic. More precisely, the ceramic is zirconia (ZrO₂) stabilized with Yttrium (Y). For example, this ceramic contains around 6% Yttrium in the form of Y₂O₃ oxide. In this embodiment, guide 100 is made entirely of zirconia (ZrO₂) stabilized with Yttrium (Y) in the form of Y₂O₃ oxide. The roughness Ra of the friction face 104 is equal to 0.03 μm. More precisely, the roughness of face 104 was measured thirty times using the following equipment and settings:
Equipment brand: MAHR
Controller part number: MarSurf M400
Feed unit reference: MarSurf SD26
Stylus part no.: 6852404 BWF A 4-4.5-2/90° (90° tip with 2 μm radius)
Cut-off length Lc 0.08 mm
Evaluation length 5 times 0.08 mm
Ls filter function
   The average of the thirty measurements obtained is equal to 0.0305 μm and the standard deviation of these thirty measurements is equal to 0.0029 μm.

Guide 100 is currently marketed by GF Machining Solution® as “Inletbush for Brake”, part number 326864, in their online catalog at https://ecatalog.gfms.com/gfms/fr/USD/search/326864.

In step 1), the angle β between direction D and axis 102 is 30°. Thus, the wire comes into contact with the face 104 at a point 120 located just after the inlet 106. The tangent at point 120 is parallel to direction D. Thus, during step 1), the wire advances inside the guide 100, passing successively through the inlet 106, then the outlet 108, then the opening 112 and finally the opening 116. After opening 116, the wire moves along a path 122 coincident with axis 102. Under these conditions, during step 1), the wire rubs only on face 104.

Preferably, in step 1), the axis 102 is vertical, so that the dust generated by the wire rubbing against the face 104 falls below the opening 116. For example, during step 1), the falling dust is collected in a container located beneath opening 116. For example, the container is a circular adhesive pad three to four centimetres in diameter. This adhesive pad is positioned just below opening 116, with its adhesive side facing towards opening 116. Before the wire is fed through, a slot is made in this pad to connect its periphery to its center. This slot allows the wire to be introduced into the pad until it passes through the center of the pad. Then, in step 1), the wire passes through the pad and the dust sticks to the adhesive side. In step 2), the dust collected in this container is weighed. Here, the adhesive pad is weighed before and after step 1). The difference between these two measurements of the pad's weight is equal to the weight of the dust collected.

Using this method, the friction resistance measured for standard wire is 7 mg/km and the friction resistance measured for wire 2 is 2 mg/km.

### Chapter III: Variants:

### Electrode Wire Variants:

The outer face of layer 12 can be covered with a thin film of the lubricant used in drawing step 84.

### Manufacturing Method Variants:

Alternatively, if the blank wire with the desired diameter D₀ is commercially available, it is not drawn in step 80 before step 82.

Other methods of carrying out oxidation step 82 are also possible. For example, instead of placing an entire spool of blank wire in an furnace, the blank wire is unwound, passed through a heating tunnel and then wound onto a spool again as it exits the tunnel. Inside the tunnel, the temperature is equal to T_{four}. Thus, in this variant, the blank wire is heated to temperature T_{four} portion after portion. The problem of the time required to obtain a uniform temperature across an entire coil of blank wire is therefore eliminated. In this case, it is possible to use a higher temperature T_{four} and a very short duration D_{four}. For example, when a heat tunnel is used, the temperature value T_{four} can be higher than 600° C. or 700° C. The speed at which the blank wire passes through the tunnel is then adjusted so that the duration D_{four}, during which a portion of the blank wire remains inside the tunnel, enables the desired thickness e₀ to be achieved.

Oxidation step 82 can also be carried out in a medium other than the earth's atmosphere. For example, step 82 can also be carried out in a medium containing more than 20% or 30%, by volume, of oxygen.

In another variant of step 82, the temperature T_{four} varies over the duration D_{four}. For example, the temperature T_{four} increases continuously over the duration D_{four}.

Oxidized blank wire can also be cooled in other ways. For example, the furnace is switched off and the coil left inside the furnace until it reaches room temperature.

Other lubricants can be used when drawing the oxidized blank wire. For example, the lubricant used is an aqueous PEG solution with an average molar mass of between 200 and 1400 g/mol, i.e. the same solution used to cool the electrode wire after stress-relief annealing.

In a simplified embodiment, in step 84, stress relief annealing is omitted. In this case, the electrode wire is simply dipped in the cold PEG bath. In another variant, dipping in the cold PEG bath is omitted.

Several of the variants described above can be combined in a single embodiment.

### Chapter IV: Advantages of the Described Embodiments:

The fact that the zinc oxide layer is formed directly on the peripheral face of the metal core makes it possible to manufacture this zinc oxide layer simply by oxidizing the brass peripheral face of a blank wire. In this way, it is not necessary to deposit a zinc layer on the peripheral face of the blank wire, as is the case, for example, in the manufacture of a wire in accordance with the teaching given in patent U.S. Pat. No. 8,338,735B2. In particular, it is emphasized that the deposition, by electrodeposition, of a zinc layer on a blank wire consumes much more energy than the heat treatment step. Thus, the electrode wire described herein can be manufactured by simpler and more economical methods.

The fact that the thickness of the oxide layer is greater than 100 nm improves machining speed and, in particular, makes it possible to achieve machining speeds close to or greater than those of a electrode wire with a fractured gamma-phase copper-zinc alloy coating such as that described in U.S. Pat. No. 8,338,735B2.

The fact that the thickness of the oxide layer is less than 461 nm improves its adhesion to the metal core.

The fact that the thickness e₁₂ is greater than 160 nm makes it possible to achieve a higher machining speed than that obtained with a electrode wire comprising a fractured gamma-phase copper-zinc alloy coating such as that described in U.S. Pat. No. 8,338,735B2.

The fact that the frictional resistance of the zinc oxide layer is less than 7 mg/km limits the amount of dust produced by the electrode wire when it is used to machine a workpiece. This limits the amount of dirt produced by the electrode wire when it is used to machine a workpiece. It also avoids the need to coat this zinc oxide layer with a varnish as described in application JPS61203223A. Problems caused by the presence of this varnish on the surface of the electrode wire can therefore be avoided.

The fact that the zinc oxide layer is the surface layer of the electrode wire increases machining speed.

The fact that the zinc concentration on the peripheral face is higher than 36 atomic % further enhances machining performance.

The fact that the diameter D₀ is between 1.3*D₂ and 6*D₂ guarantees that the coefficient c₁ of diameter reduction during wire drawing is greater than 1.3 and therefore that the breaking load of the electrode wire produced is greater than 700 N/mm².

The fact that the diameter D₀ is between 1.3*D₂ and 6*D₂, combined with the fact that the thickness e₀ is between 100*(D₀/D₂) nm and 600 nm, makes it possible to manufacture a electrode wire whose thickness e₁₂ is between 100 nm and 461 nm.

The fact that the thickness e₀ is less than 600 nm prevents part of the zinc oxide layer from being stripped off during the drawing process. Since there is no stripping of part of the zinc oxide layer, the thickness e₁₂ is well controlled and reproducible.

The fact that the maximum temperature reached during heat treatment is between 400° C. and 500° C. means that heat treatment lasts at least six hours. Such a long heat treatment time ensures a uniform temperature throughout a coil of blank wire heated in the furnace, and therefore a more uniform zinc oxide layer along the entire length of the blank wire.

By reducing the diameter of the oxidized blank wire by a factor of more than two, a breaking load of over 770 N/mm² can be achieved.

1. An electrode wire for electrical discharge machining having a breaking load greater than 400 N/mm², the electrode wire comprising:
a metal core having a peripheral face, this metal core being made of a single copper-zinc alloy, and
a layer of zinc oxide formed directly on the peripheral face of the metal core and covering the peripheral face of the metal core,
wherein an average thickness of the zinc oxide layer is in a range of from 100 nm to 461 nm.

2. The electrode wire according to claim 1, wherein the average thickness of the zinc oxide layer is greater than or equal to 105 nm.

3. The electrode wire according to claim 1, wherein a friction resistance of the zinc oxide layer is less than 7 mg/km when measured using the following method:
at room temperature, run 1 km of wire at a speed of 80 m/min under a tension of 12 N over a friction face whose longitudinal cross-section in a cutting plane is a circular arc of radius 33 mm, the circular arc beginning at an inlet and ending at an outlet, the friction face being made of zirconia (ZrO₂) stabilized with Yttrium (Y) and the roughness Ra of this friction face being equal to 0.03 μm, the wire coming into contact with the friction face at a contact point located between the inlet and the outlet and following a rectilinear trajectory contained in a cutting plane and forming with a tangent at the outlet an angle of 30° and separating from the friction face at the outlet following a trajectory parallel to the tangent at the outlet, then
weigh an amount of dust that has come off the wire when the running of the kilometer of wire has been completed, a weight of the dust being a measure of the frictional resistance expressed in mg/km.

4. The electrode wire according to claim 3, wherein the zinc oxide layer is a surface layer of the electrode wire.

5. The electrode wire according to claim 1, wherein a zinc concentration of the copper-zinc alloy of the metal core is greater than or equal to 36 atomic %.

6. The electrode wire according to claim 5, wherein the zinc concentration of the copper-zinc alloy is less than 42 atomic %.

7. The electrode wire according to claim 1, wherein a breaking load of the electrode wire is greater than 450 N/mm².

8. The electrode wire according to claim 7, wherein the breaking load of the electrode wire is greater than 700 N/mm².

9. The electrode wire according to claim 1, wherein the zinc oxide of the zinc oxide layer is obtained by heat treatment in a presence of oxygen so that the zinc oxide is composed, in atomic percent:
over 90% zinc and oxygen,
more than 5% copper, and
a remainder being made up of various residues.

10. A method of manufacturing an electrode wire, the method comprising:
supplying a metal blank wire having a peripheral face, the blank wire being made of a single copper-zinc alloy having a zinc concentration greater than 20 atomic %, a diameter D₀ of the blank wire being in a range of from 1.3*D₂ to 6*D₂, where D₂ is a final diameter of the electrode wire to be manufactured by the method, and then
oxidizing a peripheral face of the supplied blank wire to obtain an oxidized blank wire having a zinc oxide layer directly on the peripheral face, the zinc oxide layer covering the peripheral face, the oxidation of the blank wire supplied being obtained by subjecting the blank wire to a heat treatment in a presence of an oxygen-containing gas, the heat treatment being configured to generate a layer of zinc oxide on the peripheral face of the blank wire whose average thickness e₀ is in a range of from 130 nm to 600 nm, then
drawing the oxidized blank wire to obtain the electrode wire of diameter D₂ and in which the zinc oxide layer forms the outer face of the electrode wire,
wherein:
the heat treatment is configured to obtain a zinc oxide layer whose thickness is in a range of from 100*(D₀/D₂) nm to 600 nm, and
during the heat treatment, a pressure of an oxygen-containing gas exceeds 50 kPa.

11. The method according to claim 10, wherein the oxidizing of the peripheral face of the blank wire comprises:
heating the blank wire at a constant temperature T_{four} for a duration D_{four} in a range from 0.8*e₀²/[k*exp(−Q/(R*T_{four}))] to 1.2*e₀²/[k*exp(−Q/(R*T_{four}))], where:
e₀ is the desired thickness of the zinc oxide layer
k=2.418*10⁻⁷ m²/s,
Q=152 KJ/mol,
R=8.314 J/mol/K, and
exp( . . . ) is an exponential function, then
at the end of the duration D_{four}, cooling the oxidized blank wire to below 35° C. before drawing.

12. The method according to claim 11, wherein the oxidizing of the peripheral face of the blank wire comprises:
placing a coil of blank wire inside an furnace heated to a temperature T_{four}, the temperature T_{four} being in a range from 400° C. to 500° C., then
leaving the coil inside the furnace for the duration of D_{four} then removing the coil from the furnace and cooling the coil until a temperature of the oxidized blank wire drops below 35° C. before drawing.

13. The method according to claim 10, wherein the drawing reduces the diameter D₀ of the oxidized blank wire by a factor greater than two.

14. The method according to claim 10, wherein, after drawing the oxidized blank wire to obtain the electrode wire of diameter D₂, the method comprises stress-relief annealing to minimize residual stresses in the electrode wire and then dipping the electrode wire in a bath containing an aqueous solution of polyethylene glycols with an average molar mass in a range from 200 to 1400 g/mol, a temperature of the aqueous solution being below 35° C.

15. The method according to claim 10, wherein the heat treatment is configured to obtain the zinc oxide layer whose thickness is in a range of from 120*(D₀/D₂) nm to 600 nm.

16. The method according to claim 13, wherein the drawing reduces the diameter Do of the oxidized blank wire by a factor greater than 2.1.

17. The electrode wire according to claim 2, wherein the average thickness of the zinc oxide layer is greater than or equal to 160 nm.

18. The electrode wire according to claim 5, wherein a zinc concentration of the copper-zinc alloy of the metal core is greater than or equal to 40 atomic %.

19. The electrode wire according to claim 7, wherein a breaking load of the electrode wire is greater than 500 N/mm².

20. The method according to claim 10, wherein the heat treatment is configured to obtain the zinc oxide layer whose thickness is in a range of from 120*(D₀/D₂) nm to 600 nm.
